(19) United States
(12) Patent Application Publication
(10) Pub. No.: US 2004/0035634 A1
(43) Pub. Date: Feb. 26, 2004

(54) Pneumatically clamped wellbore seismic receiver

(76) Inventor: Horst Rueter, Houston, TX (US)

Correspondence Address: Richard A. Fagin, 11607 Glen Knoll Ct., Houston, TX, 77077, US

(21) Appl. No.: 10/228,375

(22) Filed: Aug. 26, 2002

(51) Int. Cl. G01V 1/16

(52) U.S. Cl. 181/122; 181/104

(57) ABSTRACT

A wellbore seismic receiver system is disclosed which includes a system housing adapted to traverse a wellbore and a sensor housing adapted to be placed in contact with a wall of the wellbore. The sensor housing has at least one seismic sensor disposed therein. A compliant chamber couples the sensor housing to the system housing, and a controllable source of pressurized gas is coupled to an interior of the chamber. The gas source is adapted to selectively pressurize the chamber to place the sensor housing in contact with the wall of the wellbore.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

1. Field of the Invention

The invention relates generally to the field of seismic surveying from inside wellbores drilled through earth formations. More particularly, the invention relates to methods and apparatus for acoustically coupling seismic sensing elements to the earth formations surrounding a wellbore.

2. Background Art

Wellbore seismic surveying known in the art includes lowering a seismic receiver system into a wellbore drilled through the earth. Typically the receiver system is lowered into the wellbore at one end of an armored electrical cable. When the receiver system reaches a selected depth in the wellbore, a “clamping” device forming part of the receiver system is actuated. The clamping device causes the receiver system to be placed into firm contact with the wall of the wellbore so that seismic energy which reaches the wellbore at the position of the receiver system will be well coupled to receiver elements inside the receiver system housing. A typical example of an arrangement of receiver elements inside a housing having a clamping system is shown in U.S. Pat. No. 5,438,169 issued to Kennedy et al. Other wellbore seismic receiver systems are described in U.S. Pat. Nos. 6,170,601; 6,006,855; 5,864,099; 5,200,581; 5,189,262; and 4,987,969.

To summarize clamping systems known in the art, one or more laterally extending elements such as arms, linkages, hydraulically actuated pistons or similar devices are actuated to extend from the main body of the receiver system housing to place a part of the system housing having the receiver elements disposed therein placed in firm contact with the wellbore wall.

An objective of the design of wellbore seismic receiver systems is to optimize the frequency response of the instrument with respect to seismic energy which reaches the wellbore. One objective of clamping systems, therefore, is to efficiently acoustically couple the mass of the receiver system housing to the wall of the wellbore so that motion of the formations caused by seismic energy is efficiently coupled to the receiver system housing. Wellbore seismic systems known in the art have a frequency response which is somewhat limited, mainly because of the mass of the system housing.

Wellbore seismic receivers known in the art also have substantial coupling of noise from other parts of the instrument system lowered into the wellbore.

Designs known in the art for wellbore seismic receiver systems frequently have insufficient acoustic isolation of the receiver elements from the remainder of the receiver system.

It is desirable to have a wellbore seismic receiver system which has improved frequency response, and reduced noise coupled from other parts of the instrument system.

### SUMMARY OF INVENTION

One aspect of the invention is a wellbore seismic receiver system which includes a system housing adapted to traverse a wellbore. The system includes a sensor housing adapted to be placed in contact with a wall of the wellbore. The sensor housing has at least one seismic sensor disposed therein. A compliant chamber couples the sensor housing to the system housing. A controllable source of pressurized gas is coupled to an interior of the chamber. The gas source is adapted to selectively pressurize the chamber to place the sensor housing in contact with the wall of the wellbore.

In one embodiment, the seismic sensor includes three mutually orthogonal accelerometers.

In one embodiment, the system includes a pressure sensor for measuring hydrostatic pressure in the wellbore. The pressure sensor is operatively coupled to the gas source so as to cause the gas source to substantially balance pressure in the chamber with hydrostatic pressure in the wellbore.

In one embodiment, the sensor housing is made from a material which has a density approximately the same as the surrounding earth formations.

In one embodiment, the sensor housing includes a triaxial magnetometer.

Measurements of DC gravity made by the three orthogonal accelerometers in one embodiment may be combined with measurements from the triaxial magnetometers to determine the orientation of the sensor housing with respect to a geographic reference.

Other aspects and advantages of the invention will be apparent from the following description and the appended claims.

### BRIEF DESCRIPTION OF DRAWINGS

FIG. 1 shows one embodiment of a seismic receiver system according to the invention.

FIG. 2 shows a different embodiment of a seismic receiver system.

### DETAILED DESCRIPTION

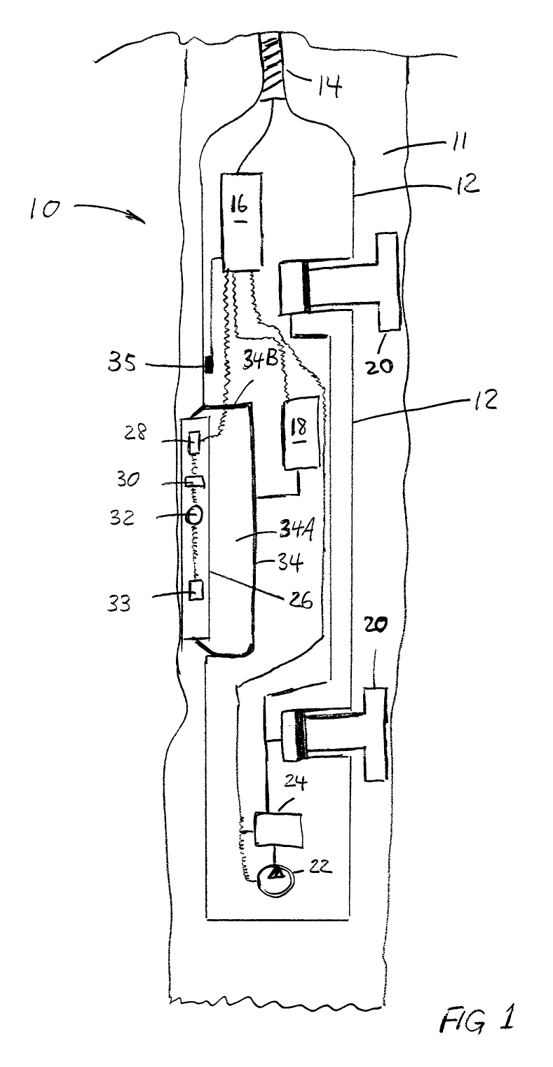

FIG. 1 shows one embodiment of a wellbore seismic receiver system 10 according to the invention. The receiver system 10 is adapted to be lowered into a wellbore 11 drilled through earth formations 13. The system 10 as shown in FIG. 1 is lowered into the wellbore 11 and withdrawn from the wellbore 11 at one end of an armored electrical cable 14. Typically the electrical cable 14 will be extended and retracted by a winch (not shown) or similar spooling device well known in the art. The cable 14 is used to transmit electrical power from equipment (not shown) disposed at the earth's surface, and to send signals corresponding to detected seismic energy back to the equipment (not shown) at the earth's surface.

It should be clearly understood, however, that conveyance into the wellbore 11, and power and signal transmission using the armored electrical cable 14 such as shown in FIG. 1 is not a limitation on the invention. Other embodiments of a wellbore seismic receiver system according to the invention may be conveyed into the wellbore such as by drill pipe, coiled tubing or other conveyances well known in the art. Similarly, obtaining electrical power from the earth's surface and transmitting signals to the surface directly from the system 10 using the cable 14 is not intended to limit the scope of the invention. Other types of power sources which may be included in other embodiments of a system according to the invention, such as fluid operated turbines or batteries are well known in the art. Detected seismic signals may be recorded in appropriate storage devices in other embodiments of a system according to the invention, rather than, or in addition to, transmission of such signals to the earth's surface

Components of the receiver system 10 are generally disposed inside a system housing 12 adapted to traverse the wellbore 11. Principal components of the system 10 located directly inside the system housing 12 include a signal processing and control unit 16, a controllable source 18 of high pressure gas, which can operate under control of the control unit 16. This embodiment includes an hydraulic pump 22 and control valve 24 which are included to operate back-up shoes 20 actuated by hydraulically operated pistons (included in the structure of shoes 20 in FIG. 1).

Seismic energy detection components of the system 10 are generally disposed inside a sensor housing 26 adapted to be placed in firm contact with the wall of the wellbore 11. Seismic sensors 28, 30, 32, which in this embodiment can be accelerometers, are disposed in the sensor housing 26. The sensor housing 26 is coupled to the system housing 12 through a compliant gas- or air-filled chamber 34A. In this embodiment, the chamber 34A is formed by a bladder 34 disposed in an appropriately formed recess 34B in the system housing 12 and sealed against the edges of the sensor housing 26. The bladder 34 is preferably made from a compliant material such as rubber or the like, and is formed so that the sensor housing 26 is mechanically coupled to the system housing 12 only by the bladder 34 material as shown in FIG. 1. Having this arrangement of a compliant chamber 34A between the sensor housing 26 and the system housing 12 reduces transmission of noise from the system 10 to the sensor housing 26. Other materials may be used to form the bladder, such as bellows-shaped metal or the like, however using soft, compliant material such as rubber reduces acoustic coupling between the system housing 12 and the sensor housing 26.

Other embodiments of the chamber 34A may include using rubber or similar compliant material to form seal edges between the exterior surface of the recess 34B and corresponding exterior surfaces of the sensor housing 26. Irrespective of the exact manner of construction of the chamber 34A, the principle of the invention is to include a gas-filled chamber between the sensor housing 26 and the system housing 12, such that pressurization of the gas filled chamber will result in lateral extension of the sensor housing 26 from the instrument housing 12. When the sensor housing 26 is ultimately restrained from further lateral extension because it has contacted the wall of the wellbore, increased gas pressure in the chamber will cause the sensor housing 26 to be forced against the wellbore wall. However, the only substantial mechanical coupling between the sensor housing 26 and the instrument housing 12 is through the gas-filled chamber (34A in FIG. 1). The result is having a substantial clamping force applied between the wall of the wellbore 11 and the face of the sensor housing 26, while having very low acoustic coupling between the system housing 12 and the sensor housing 26.

The control unit 16 may include circuits (not shown separately) of types well known in the art for controlling operation of the various components of the system 10. Such circuits include programmable controllers such as one sold by Intel Corp. under model number EB186. The control unit 16 may also include circuits (not shown separately) of types well known in the art for receiving, amplifying, filtering and/or digitizing signals from the seismic sensors 28, 30, 32. An example of such circuits includes a digital signal processor sold by Texas Instruments, Inc. under model number TMS 320C30. The control unit 16 may be programmed to operate the various components by receiving instructions transmitted along the cable 14, or may be programmed to carry out operation automatically.

The seismic sensors 28, 30, 32 in this embodiment can be accelerometers appropriately coupled or affixed to the sensor housing 26. Alternatively, the sensors 28, 30, 32 may be geophones. The sensors 28, 30, 32 are preferably mounted such that the sensitive axis of each is orthogonal to that of the other sensors. The sensor housing 26 in this embodiment includes a triaxial magnetometer 33 of any type well known in the art. The purpose of the triaxial magnetometer will be further explained below.

The sensor housing 26 is preferably made of a material which has a density similar to typical earth formations in which the system 10 is likely to be used. Such densities typically range from about 1.6 to 2.6 gm/cc as is known in the art. Selecting a density which is close to that of the earth formations 13 will reduce seismic energy losses caused by acoustic impedance mismatch between the sensor housing 26 and the formations 13.

The high pressure gas source 18 may be a container having gas (such as nitrogen or other inert gas) or air disposed therein under very high pressure and a control valve (not shown separately) adapted to release the high pressure gas in the container into the chamber 34A under operation by the control unit 16, in order to pressurize the chamber 34A. In this embodiment, the system 10 includes a pressure sensor 35 adapted to measure hydrostatic pressure in the wellbore 11. The hydrostatic pressure thus measured is used by the control unit 16 to operate the gas source 18 to maintain pressure in the chamber 34A at substantially the same as the hydrostatic pressure in the wellbore 11 as the system 10 is lowered into and withdrawn from the wellbore 11. In this embodiment, the gas source 18 may be adapted to vent pressure in the chamber 34A to the wellbore 11 as the hydrostatic pressure decreases (when the system 10 is withdrawn from the wellbore 11), in order to maintain substantial pressure balance. Other times when the chamber pressure is reduced will be explained below with respect to operation of the system 10.

In operation, the system 10 is lowered into the wellbore 11 to a selected depth. At the selected depth, the control unit 16 actuates the hydraulic pump 22 and valves 24 to cause the back up shoes 20 to extend. Extending the back up shoes 20 reduces the amount of space between the exterior of the sensor housing 26 and the wall of the wellbore 11. It should be noted here that other embodiments of a system according to the invention may use other types of extending members, such as a back up arm operated by a ball-screw device shown in U.S. Pat. No. 5,438,169 issued to Kennedy et al. Other embodiments may not use any form of back up arm, linkage or shoe, depending on the exterior diameter of the particular system housing and the diameter of the wellbore in which the system is disposed. Therefore, the back up shoes or any similar extending device or member used to laterally move the system housing 12 may be omitted in other embodiments of a receiver system according to the invention. A practical benefit to using back up shoes or the like is that the space between the exterior face of the sensor housing 26 and the wall of the wellbore 11 can be minimized. This enables having the compliant chamber 34A increase in volume by only a small amount in order to force the sensor housing into contact with the wellbore wall. By limiting the necessary lateral extension of the sensor housing 26 from the system housing 12, the volume of the chamber 34A may be minimized. Minimizing the compliant chamber 34A volume reduces the necessary size of the gas source 18.

After the back up shoes 20 are extended, in the present embodiment the control unit 16 operates the high pressure gas source 18 to charge the chamber 34 to a pressure sufficiently above the hydrostatic pressure to place the sensor housing 26 in firm contact with the wall of the wellbore 11.

When the sensor housing 26 is firmly in contact with the wellbore wall, first, a “baseline” or “DC” measurement (measurement in the absence of seismic energy source actuation) can be made of the seismic sensors 28, 30, 32. In this embodiment, the seismic sensors 28, 30, 32 are accelerometers oriented substantially orthogonally. Making a DC measurement thus enables determining the orientation of the system 10 with respect to earth's gravity. In this embodiment, the sensor housing 26 also includes the triaxial magnetometer 33. A measurement of the orientation of the sensor housing 26 may thus be made with respect to a geographic reference such as magnetic north. When combined with the DC seismic sensor measurements, the geographic orientation of the sensor housing 26 may be fully determined. Although the seismic sensors 28, 30, 32 are shown and described as being mutually orthogonal, they may have other relative orientations as long as these orientations are known and are sufficiently different from each other to enable resolution of the direction of seismic energy and the orientation of the sensor housing 26 with respect to earth's gravity. In other embodiments, the magnetometer 33 may be omitted, and the orientation of the sensor housing 26 may be determined from the DC gravity measurements combined with a previously obtained directional survey of the trajectory of the wellbore 11.

After the DC seismic sensor measurements are made, a seismic source (not shown in FIG. 1) may be actuated, and measurements of the response of the seismic sensors 28, 30, 32 to the seismic energy which reaches the sensor housing 26 may then be amplified, filtered, and transmitted to the surface and/or stored by the control unit 16. Systems for seismic signal processing, and transmitting and/or locally recording (storing) are well known in the art. The seismic energy source (not shown) may be disposed at the earth's surface or sea surface for conventional vertical seismic profile surveys, or may be disposed in another wellbore (not shown) for cross-well seismic surveys, as is known in the art.

After seismic measurements have been made at the selected depth, the control unit 16 operates the gas source 18 to depressurize the chamber 34 to approximately the hydrostatic pressure. The control unit 16 then operates the pump 22 and valve 24 to retract the back up shoes 20. The system 10 may then be moved to a different selected depth in the wellbore 11 or may be withdrawn from the wellbore if surveying is completed. Advantageously, depressurizing the chamber 34A according to this embodiment of the invention will cause the sensor housing 26 to be moved toward the system housing 12, so as to reduce the effective diameter of the system 10 for ease of movement along the wellbore 11. As previously explained, the pressure sensor 35 provides a measurement of external hydrostatic pressure so that the gas source 18 may be operated to maintain approximate pressure balance between the chamber 34A and the external hydrostatic pressure.

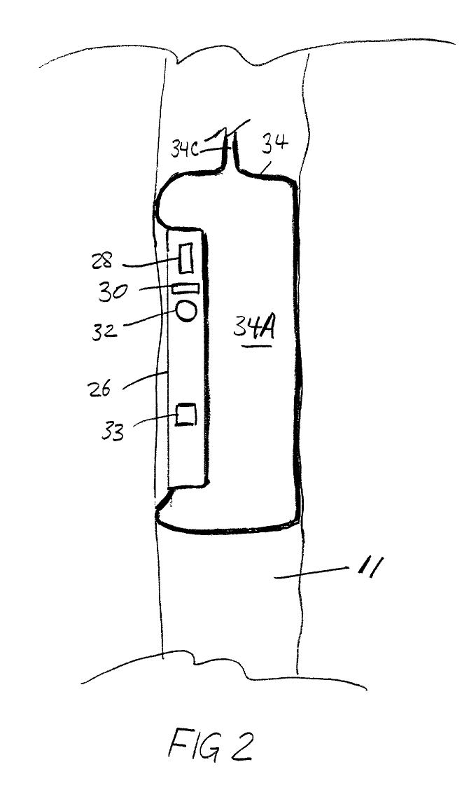

An alternative embodiment of sensor housing 26 and compliant chamber 34A is shown in FIG. 2. In the embodiment of FIG. 2, the chamber 34A is disposed entirely outside the system housing (12 in FIG. 1). In this embodiment, the chamber 34A is a bladder 34 adapted to fill substantially the entire diameter of the wellbore 11 when pressurized. Pressurization of the blabber 34 may be through an “umbilical” 34C which may include pneumatic connection of the bladder 34 to the pressurized gas source (18 in FIG. 1) and electrical connection of the sensors 28, 30, 32 and magnetometer 33 to the control unit (16 in FIG. 1). Operation of the embodiment of FIG. 2 includes inflating the bladder 34 to force the sensor housing into firm contact with the wall of the wellbore 11, and making DC and seismic measurements as described earlier with respect to FIG. 1.

An advantage that may be offered by a wellbore seismic receiver system according to the invention is improved frequency response, and reduced amounts of coupled noise, because substantially the only mechanical coupling between the sensor housing and the main system housing is a gas-filled chamber. The gas filled chamber may reduce the amount of noise coupled from elsewhere in the system 10 to the sensors 28, 30, 32.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A wellbore seismic receiver system, comprising:
a system housing adapted to traverse a wellbore;
a sensor housing adapted to be placed in contact with a wall of the wellbore, the sensor housing having at least one seismic sensor disposed therein;
a compliant chamber coupling the sensor housing to the system housing; and
a controllable source of pressurized gas coupled to an interior of the chamber, the source adapted to selectively pressurize the chamber to place the sensor housing in contact with the wall of the wellbore.

2. The system of claim 1 wherein the at least one seismic sensor comprises an accelerometer.

3. The system of claim 2 wherein the at least one seismic sensor comprises three mutually orthogonal accelerometers.

4. The system of claim 3 further comprising a triaxial magnetometer disposed in the sensor housing.

5. The system of claim 1 further comprising a pressure sensor for measuring hydrostatic pressure outside the system, the pressure sensor operatively coupled to the gas source, the gas source controllably operable to substantially balance pressure in the chamber to the hydrostatic pressure while the system is moved through the wellbore.

6. The system of claim 1 further comprising at least one back up element operatively coupled to the system housing and adapted to laterally move the system housing in the wellbore to reduce a space between an exterior face of the sensor housing and the wall of the wellbore.

7. The system of claim 1 wherein a density of the sensor housing is selected to be approximately the same as a density of earth formations penetrated by the wellbore.

8. The system of claim 1 wherein the chamber comprises a bladder made from a compliant material.
